(19) United States
(12) Patent Application Publication
(10) Pub. No.: US 2026/0044622 A1
(43) Pub. Date: Feb. 12, 2026

(54) QUERY OBFUSCATION FOR SECURE SEARCHES

(71) Applicant: International Business Machines Corporation, Armonk, NY (US)

(72) Inventors: PAWAN RAGHUNATH CHOWDHARY, San Jose, CA (US); Dinesh C. Verma, New Castle, NY (US); David James Beymer, San Jose, CA (US); Swanand Ravindra Kadhe, San Jose, CA (US)

(21) Appl. No.: 18/799,375

(22) Filed: Aug. 9, 2024

(51) Int. Cl. G06F 21/62

(52) U.S. Cl. CPC G06F 21/6227

(57) ABSTRACT

According to a present invention embodiment, a system for processing queries for secure searches comprises one or more memories and at least one processor. The system determines for a query, via a first machine learning model, a region of an embedding space corresponding to search results. The region of the embedding space is distorted along one or more dimensions to produce distorted regions in the embedding space corresponding to different search results. A second machine learning model determines modified queries corresponding to the different search results of the distorted regions to produce obfuscated queries. Results are obtained from processing the obfuscated queries. A response to the query is produced based on the results for the obfuscated queries. Embodiments of the present invention further include a method and computer program product for processing queries for secure searches in substantially the same manner described above.

### BACKGROUND

### 1. Technical Field

Present invention embodiments relate to query processing, and more specifically, to obfuscating search queries to conceal the intent of searches and perform the searches in a secure manner.

### 2. Discussion of the Related Art

Queries are processed by content providers (e.g., databases, search engines, etc.) to retrieve desired information. The queries include terms for searching the information which may include sensitive information and/or reveal the intent or target entity of a search. In order to conceal the intent or target entity of a search, conventional approaches may add decoy or dummy queries to the actual query for the search. The decoy queries basically attempt to confuse the content provider with respect to discerning the actual query. The decoy queries may be generated in various manners, including selecting decoy queries from a static set and using a large language model (LLM) to generate the decoy queries. However, the decoy query approach still provides the actual query to a content provider, thereby exposing sensitive information and the intent of the search to the content provider.

### SUMMARY

According to one embodiment of the present invention, a system for processing queries for secure searches comprises one or more memories and at least one processor coupled to the one or more memories. The system determines for a query, via a first machine learning model, a region of an embedding space corresponding to search results. The region of the embedding space is distorted along one or more dimensions to produce distorted regions in the embedding space corresponding to different search results. A second machine learning model determines modified queries corresponding to the different search results of the distorted regions to produce obfuscated queries. Results are obtained from processing the obfuscated queries. A response to the query is produced based on the results for the obfuscated queries. Embodiments of the present invention further include a method and computer program product for processing queries for secure searches in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a diagrammatic illustration of obfuscating a query according to an embodiment of the present invention.

FIG. 3 is a block diagram of an example large language model (LLM) that may be leveraged for obfuscating queries according to an embodiment of the present invention.

FIG. 4A is a diagrammatic illustration of large language models (LLMs) mapping between queries and regions of an embedding space according to an embodiment of the present invention.

FIG. 4B is a flow diagram of training the large language models (LLMs) of FIG. 4A according to an embodiment of the present invention.

FIG. 5 is a block diagram of a query module for generating modified queries according to an embodiment of the present invention.

FIG. 6A is a diagrammatic illustration of combining results from modified queries according to an embodiment of the present invention.

FIG. 6B illustrates results for an original query relative to results of obfuscated queries according to an embodiment of the present invention.

FIG. 7 is a procedural flowchart illustrating a manner of obfuscating a query according to an embodiment of the present invention.

### DETAILED DESCRIPTION

Queries are processed by content providers (e.g., databases, search engines, etc.) to retrieve desired information. The queries include terms for searching the information which may include sensitive information and/or reveal the intent or target entity of a search. In order to conceal the intent or target entity of a search, conventional approaches may add decoy or dummy queries to the actual query for the search. The decoy queries basically attempt to confuse the content provider with respect to discerning the actual query. The decoy queries may be generated in various manners, including selecting decoy queries from a static set and using a large language model (LLM) to generate the decoy queries. However, the decoy query approach still provides the actual query to a content provider, thereby exposing sensitive information and the intent of the search to the content provider.

Accordingly, an embodiment of the present invention obfuscates a query to perform a search (without sending the actual query to the content provider). The embodiment of the present invention leverages large language models (LLMs) to produce modified queries from the actual query and decoy or dummy queries that obfuscate the actual query. The modified queries and decoy queries are sent to the content provider for processing. The results of the modified queries are processed to determine a result set for the actual query as close as possible to a result from the content provider in response to the actual query. This prevents the content provider from accessing the actual query and discovering the intent or target of a search.

Typically, a user may send a query to a content provider that returns a set of records (e.g., links from a search engine, records from a database search, etc.). However, an embodiment of the present invention obfuscates the query to conceal the intent or target of a search (e.g., an entity, etc.). For example, a user may desire to discreetly search for information about an entity (without exposing information of the search, such as in logs of content providers, etc.). The embodiment of the present invention receives a query from a user, and sends a set of obfuscated queries (one or more) to a content provider instead of the original query (e.g., the original query is not sent to the content provider). The content provider returns a set of records, and the present invention embodiment selects a subset of the records as a result for the original query. The selected records are provided to the user as the result of the original query.

An embodiment of the present invention obfuscates a search query to conceal the intent of the search. The search query is converted into multiple modified queries and decoy queries. The modified queries are created to expand the set of records that are generated for the search. The modified queries may be created based on shapes selected for regions in a latent or embedding space of a large language model (LLM). The shapes are used to expand or distort the regions along selected dimensions, and corresponding queries for the distorted regions are determined by an LLM and used as the modified queries. The decoy queries are created to generate a set of records unrelated to the search query. The intersection of the set of records returned for the modified queries is determined to generate the specific set of records for the search query.

According to an aspect of the invention, there is provided a method of processing queries for secure searches. A first machine learning model of at least one processor determines for a query a region of an embedding space corresponding to search results. The at least one processor distorts the region of the embedding space along one or more dimensions to produce distorted regions in the embedding space corresponding to different search results. A second machine learning model of the at least one processor determines modified queries corresponding to the different search results of the distorted regions to produce obfuscated queries. The at least one processor obtains results from processing the obfuscated queries. The at least one processor determines a response to the query based on the results for the obfuscated queries.

This provides enhanced security for searches by obfuscating queries to conceal the intent and/or target of a search. Further, present invention embodiments produce results for a query without sending the query to a content provider. This provides enhanced security by enabling performance of the query without exposing the intent and/or target of the search to the content provider.

In embodiments, the first machine learning model and the second machine learning model each include a large language model. The large language models (LLMs) may be configured to control the level of security or obfuscation, thereby controlling computer performance and conserving computing resources. Further, the security is provided without use of ontologies or knowledge graphs which require resources for updating and maintenance.

In embodiments, the obfuscated queries include one or more decoy queries. This provides enhanced security for searches by increasing obfuscation of the original query to conceal the intent and/or target of a search from a content provider.

In embodiments, the method further comprises generating, via the at least one processor, the one or more decoy queries based on randomly selected regions in the embedding space. This provides enhanced security for searches by increasing the obfuscation of the original query to conceal the intent and/or target of the search from a content provider.

In embodiments, producing the response to the query comprises determining regions of the embedding space corresponding to the results for the obfuscated queries, and producing the response to the query based on an intersection of the regions corresponding to the results for the modified queries. This produces results for a query without sending the query to a content provider. This also provides enhanced security by enabling performance of the query without exposing the intent and/or target of the search to a content provider.

In embodiments, producing the response to the query comprises processing the query against the results for the obfuscated queries to produce the response. This produces results for a query without sending the query to a content provider. This also provides enhanced security by enabling performance of the query without exposing the intent and/or target of the search to a content provider.

In embodiments, the region includes one of a rectangular shaped region and a circular shaped region. This provides various levels of distortion to produce varying modified queries and increase obfuscation of the original query to conceal the intent and/or target of the search from a content provider. In other embodiments, other types of shapes of regions can be used.

In embodiments, the one or more dimensions and an amount of distortion are randomly selected. This enables the region to be distorted in varying dimensions by various amounts to produce a variety of modified queries. The modified queries increase obfuscation of the original query to conceal the intent and/or target of the search and provide secure searching.

According to an aspect of the invention, there is provided a system for processing queries for secure searches comprising one or more memories, and at least one processor coupled to the one or more memories. The at least one processor determines for a query, via a first machine learning model, a region of an embedding space corresponding to search results. The at least one processor distorts the region of the embedding space along one or more dimensions to produce distorted regions in the embedding space corresponding to different search results. The at least one processor determines, via a second machine learning model, modified queries corresponding to the different search results of the distorted regions to produce obfuscated queries. The at least one processor obtains results from processing the obfuscated queries. The at least one processor produces a response to the query based on the results for the obfuscated queries.

This provides enhanced security for searches by obfuscating queries to conceal the intent and/or target of a search. Further, present invention embodiments produce results for a query without sending the query to a content provider. This provides enhanced security by enabling performance of the query without exposing the intent and/or target of the search to the content provider.

In embodiments of the system, the first machine learning model and the second machine learning model each include a large language model. The large language models (LLMs) may be configured to control the level of security or obfuscation, thereby controlling computer performance and conserving computing resources. Further, the security is provided without use of ontologies or knowledge graphs which require resources for updating and maintenance.

In embodiments of the system, the obfuscated queries include one or more decoy queries. This provides enhanced security for searches by increasing obfuscation of the original query to conceal the intent and/or target of a search from a content provider.

In embodiments of the system, the at least one processor is further configured to generate the one or more decoy queries based on randomly selected regions in the embedding space. This provides enhanced security for searches by increasing the obfuscation of the original query to conceal the intent and/or target of the search from a content provider.

In embodiments of the system, producing the response to the query comprises determining regions of the embedding space corresponding to the results for the obfuscated queries, and producing the response to the query based on an intersection of the regions corresponding to the results for the modified queries. This produces results for a query without sending the query to a content provider. This also provides enhanced security by enabling performance of the query without exposing the intent and/or target of the search to a content provider.

In embodiments of the system, producing the response to the query comprises processing the query against the results for the obfuscated queries to produce the response. This produces results for a query without sending the query to a content provider. This also provides enhanced security by enabling performance of the query without exposing the intent and/or target of the search to a content provider.

In embodiments of the system, the region includes one of a rectangular shaped region and a circular shaped region. This provides various levels of distortion to produce varying modified queries and increase obfuscation of the original query to conceal the intent and/or target of the search from a content provider.

In embodiments of the system, the one or more dimensions and an amount of distortion are randomly selected. This enables the region to be distorted in varying dimensions by various amounts to produce a variety of modified queries. The modified queries increase obfuscation of the original query to conceal the intent and/or target of the search and provide secure searching.

According to an aspect of the invention, there is provided a computer program product for processing queries for secure searches. The computer program product comprising one or more computer readable storage media having program instructions collectively stored on the one or more computer readable storage media. The program instructions are executable by at least one processor to cause the at least one processor to determine, via a first machine learning model, a region of an embedding space corresponding to search results. The program instructions cause the at least one processor to distort the region of the embedding space along one or more dimensions to produce distorted regions in the embedding space corresponding to different search results. The program instructions cause the at least one processor to determine, via a second machine learning model, modified queries corresponding to the different search results of the distorted regions to produce obfuscated queries. The program instructions cause the at least one processor to obtain results from processing the obfuscated queries. The program instructions cause the at least one processor to produce a response to the query based on the results for the obfuscated queries.

This provides enhanced security for searches by obfuscating queries to conceal the intent and/or target of a search. Further, present invention embodiments produce results for a query without sending the query to a content provider. This provides enhanced security by enabling performance of the query without exposing the intent and/or target of the search to the content provider.

In embodiments of the computer program product, the first machine learning model and the second machine learning model each include a large language model. The large language models (LLMs) may be configured to control the level of security or obfuscation, thereby controlling computer performance and conserving computing resources. Further, the security is provided without use of ontologies or knowledge graphs which require resources for updating and maintenance.

In embodiments of the computer program product, the obfuscated queries include one or more decoy queries. This provides enhanced security for searches by increasing obfuscation of the original query to conceal the intent and/or target of a search from a content provider.

In embodiments of the computer program product, the program instructions further cause the at least one processor to generate the one or more decoy queries based on randomly selected regions in the embedding space. This provides enhanced security for searches by increasing the obfuscation of the original query to conceal the intent and/or target of the search from a content provider.

In embodiments of the computer program product, producing the response to the query comprises determining regions of the embedding space corresponding to the results for the obfuscated queries, and producing the response to the query based on an intersection of the regions corresponding to the results for the modified queries. This produces results for a query without sending the query to a content provider. This also provides enhanced security by enabling performance of the query without exposing the intent and/or target of the search to a content provider.

In embodiments of the computer program product, producing the response to the query comprises processing the query against the results for the obfuscated queries to produce the response. This produces results for a query without sending the query to a content provider. This also provides enhanced security by enabling performance of the query without exposing the intent and/or target of the search to a content provider.

In embodiments of the computer program product, the region includes one of a rectangular shaped region and a circular shaped region, and the one or more dimensions and an amount of distortion are randomly selected. This provides various levels of distortion to produce varying modified queries and increase obfuscation of the original query to conceal the intent and/or target of the search from a content provider. This also enables the region to be distorted in varying dimensions by various amounts to produce a variety of modified queries. The modified queries increase obfuscation of the original query to conceal the intent and/or target of the search and provide secure searching.

According to an aspect of the invention, there is provided a method of processing queries for secure searches. At least one processor distorts a region of an embedding space corresponding to search results for a query along one or more dimensions to produce distorted regions in the embedding space corresponding to different search results. The at least one processor determines modified queries corresponding to the different search results of the distorted regions to produce obfuscated queries. The at least one processor determines a response to the query based on results for the obfuscated queries.

This provides enhanced security for searches by obfuscating queries to conceal the intent and/or target of a search. Further, present invention embodiments produce results for a query without sending the query to a content provider. This provides enhanced security by enabling performance of the query without exposing the intent and/or target of the search to the content provider.

According to an aspect of the invention, there is provided a computer program product for processing queries for secure searches. The computer program product comprising one or more computer readable storage media having program instructions collectively stored on the one or more computer readable storage media. The program instructions are executable by at least one processor to cause the at least one processor to distort a region of an embedding space corresponding to search results for a query along one or more dimensions to produce distorted regions in the embedding space corresponding to different search results. The program instructions cause the at least one processor to determine modified queries corresponding to the different search results of the distorted regions to produce obfuscated queries. The program instructions cause the at least one processor to produce a response to the query based on results for the obfuscated queries.

This provides enhanced security for searches by obfuscating queries to conceal the intent and/or target of a search. Further, present invention embodiments produce results for a query without sending the query to a content provider. This provides enhanced security by enabling performance of the query without exposing the intent and/or target of the search to the content provider.

In an example scenario, a user may desire to discreetly search for information about an entity (without exposing information of the search, such as in logs of content providers, etc.). For example, a user may be searching for information about an entity in relation to a consequential and sensitive (or confidential) event (e.g., merger, acquisition, sale, etc.). The user does not want information concerning the event to be exposed by the search (e.g., placed in logs of content providers, intercepted, etc.). An embodiment of the present invention receives a query from the user, and generates a set of obfuscated queries (one or more). The obfuscated queries are sent to a content provider instead of the original query (e.g., the original query is not sent to the content provider). The content provider returns a set of records for the obfuscated queries, and the present invention embodiment selects a subset of the records as a result for the original query. The selected records are provided to the user as the result of the original query without exposing the original query with sensitive information to the content provider (or other entities).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

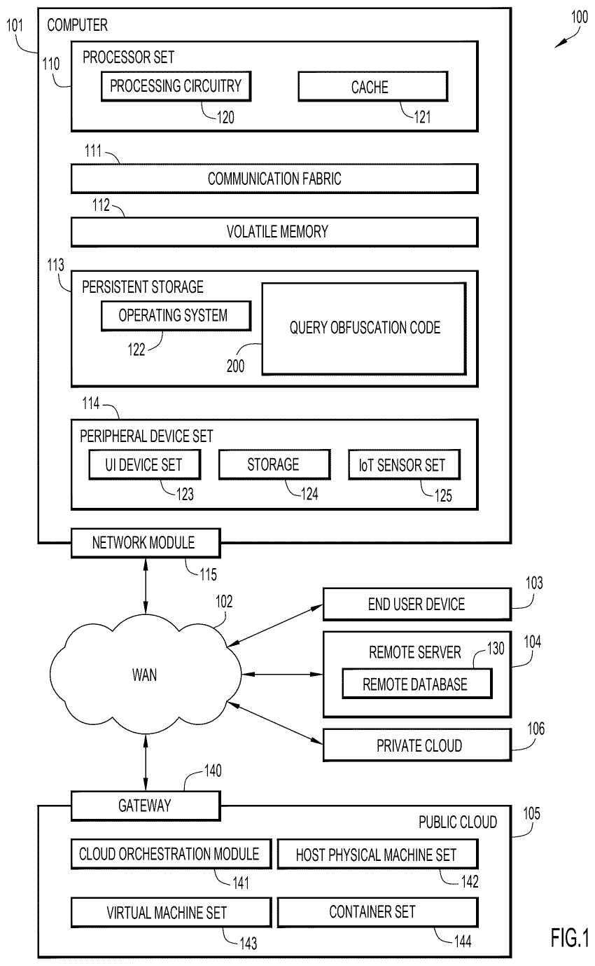

Referring to FIG. 1, computing environment 100 contains an example of an environment for the execution of at least some of the computer code involved in performing the inventive methods, such as query obfuscation code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip. ” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images. ” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

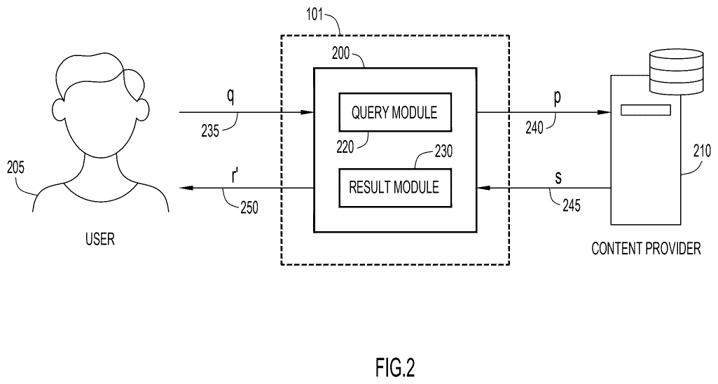

A manner of obfuscating a query according to an embodiment of the present invention is illustrated in FIG. 2. Initially, a user 205 (e.g., via an end user device 103, etc.) provides a query 235 (e.g., q as shown in FIG. 2) to computer 101 including query obfuscation code 200. The query obfuscation code includes a query module 220 for producing obfuscated queries 240 (e.g., p as shown in FIG. 2) for query 235, and a result module 230 to combine results of the obfuscated queries 245 (e.g., s as viewed in FIG. 2) from a content provider 210 to produce a result 250 for query 235 (e.g., r′ as viewed in FIG. 2). The obfuscated queries include modified queries produced from query 235 and decoy or dummy queries.

Obfuscated queries 240 from query module 220 are provided to content provider 210 (e.g., search engine, database, data source, etc.) that retrieves information satisfying the obfuscated queries and produces results 245 for the obfuscated queries. In other words, each obfuscated query returns a set of one or more records from content provider 210 (e.g., links from a search engine, database records, etc.). Each record corresponds to a point in an abstract multi-dimensional vector (or embedding) space. Accordingly, instead of sending original query 235 to content provider 210, multiple different queries (obfuscated queries 240) are provided to the content provider.

Results 245 associated with the modified queries of obfuscated queries 240 are processed by result module 230 to produce a result 250 for query 235 (e.g., while results from the decoy queries are ignored or discarded). Thus, a response from directly processing query 235 may be reconstructed from results 245 of the modified queries by determining an intersection of the records returned in response to the modified queries. Alternatively, actual query 235 may be applied to the results of the modified queries (and optionally the results of the decoy queries) to determine the response.

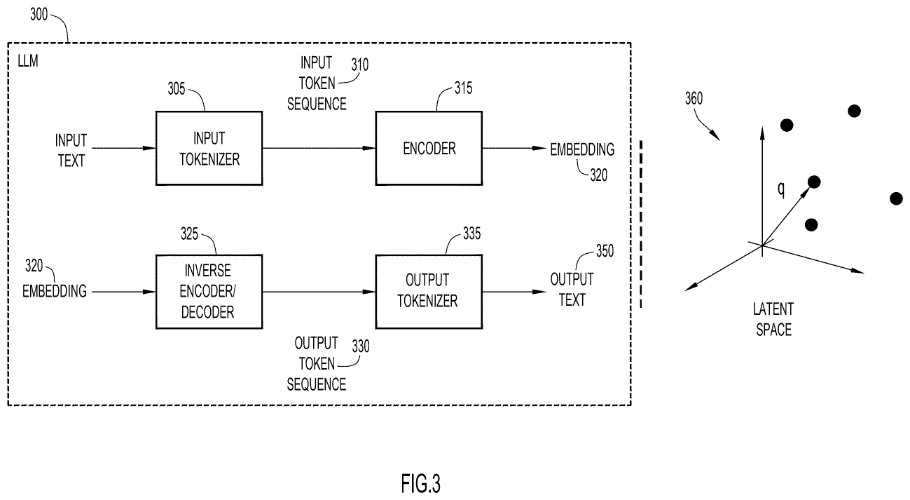

An example large language model (LLM) that may be leveraged for generating obfuscated queries according to an embodiment of the present invention is illustrated in FIG. 3. The large language model (LLM) may be implemented by, or include, any quantity of any conventional or other machine learning and/or natural language processing (NLP) models (e.g., mathematical/statistical models, classifiers, feed-forward (fully or partially connected), recurrent (RNN), convolutional (CNN), or other neural networks, deep learning models, long short-term memory (LSTM), attention-based methods/transformers, Large Language Model (LLM), entity extraction, relationship extraction, part-of-speech (POS) taggers, semantic analysis, etc.).

By way of example, a large language model (LLM) 300 includes an input tokenizer 305, an encoder 315, an inverse encoder (or decoder) 325, and an output tokenizer 335. Input tokenizer 305 of LLM 300 receives input text (e.g., prompt, inquiry, etc.) and parses the input text into tokens (e.g., words, n-grams, etc.). The input tokenizer further assigns each token an identifier or index associated with a vocabulary to produce an input token sequence 310. The input tokenizer may be implemented by any conventional or other natural language processing (NLP) component or tokenizer producing any types of tokens and/or identifiers from text. The tokens may include any quantity of any units of text (e.g., words, n-grams, etc.), and be associated with any vocabulary (e.g., words, phrases, any natural language, etc.).

Encoder 315 processes input token sequence 310 to produce an embedding 320 for the input token sequence. The embedding may include a word embedding or vector representation of the input token sequence. Basically, one or more words (or tokens) may be represented by a vector having numeric elements corresponding to a plurality of dimensions of a latent or embedding space 360. Words (or tokens) with similar meanings have similar word embeddings or vector representations (and are grouped near each other or in the same region of the embedding space). The word embeddings are produced from machine learning techniques or models (e.g., neural network, etc.) based on an analysis of word usage in a collection of text or documents. The embeddings or vector representations may be pre-existing, and/or produced using any conventional or other tools or techniques (e.g., GLOVE, WORD2VEC, etc.).

Encoder 315 may include any conventional or other machine learning models (e.g., mathematical/statistical, classifiers, feed-forward, recurrent, convolutional, deep learning, or other neural networks, etc.) to produce the embeddings. By way of example, encoder 315 may employ a neural network. For example, neural networks may include an input layer, one or more intermediate layers (e.g., including any hidden layers), and an output layer. Each layer includes one or more neurons, where the input layer neurons receive input (e.g., token information, feature vectors, etc.), and may be associated with weight values. The neurons of the intermediate and output layers are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques. For example, the machine learning of the neural network may be performed using a training set based on an analysis of word usage in a collection of text or documents, where the neural network attempts to produce the provided output (or embedding) and uses an error from the output (e.g., difference between produced and known outputs) to adjust weight (and bias) values (e.g., via backpropagation or other training techniques).

The embeddings are represented by a vector having numeric elements corresponding to a plurality of dimensions, and are mapped to latent or embedding space 360. Thus, embeddings mapped to the same regions of the latent or embedding space have similar properties (e.g., semantic meanings, etc.).

Embedding 320 may be processed by inverse encoder (or decoder) 325. The decoder basically determines a result of the inquiry based on the embedding and produces an output token sequence 330 corresponding to the result. The output token sequence includes tokens and corresponding identifiers or indices for a vocabulary. The vocabulary may be the same or different vocabulary relative to the vocabulary for the input tokenizer. Decoder 325 may include any conventional or other machine learning models (e.g., mathematical/statistical, classifiers, feed-forward, recurrent, convolutional, deep learning, or other neural networks, etc.) to produce the output token sequence. By way of example, decoder 325 may employ a neural network described above that is trained to map embeddings (representing the result of the inquiry) to token sequences in substantially the same manner described above.

Output token sequence 330 is processed by output tokenizer 335 to produce output text 350 (e.g., a sentence, phrase, etc.) corresponding to the result of the inquiry. The output tokenizer basically performs a reverse operation of input tokenizer 310, where the output tokenizer produces text from a sequence of tokens. The text may be determined based on the terms in the vocabulary (e.g., words, etc.) indicated by the indices of the tokens. The output tokenizer may be implemented by any conventional or other natural language processing (NLP) component or tokenizer producing text from any types of tokens. The tokens may include any quantity of any units of text (e.g., words, n-grams, etc.), and be associated with any vocabulary (e.g., words, phrases, any natural language, etc.).

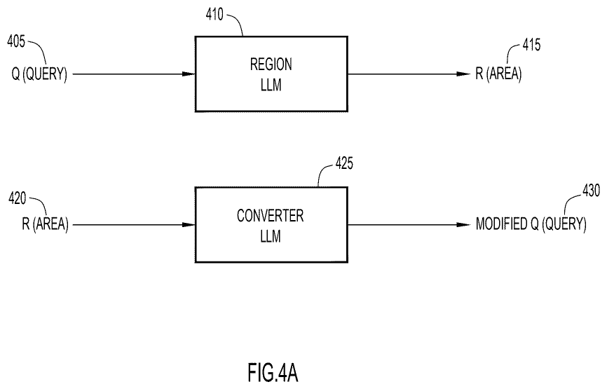

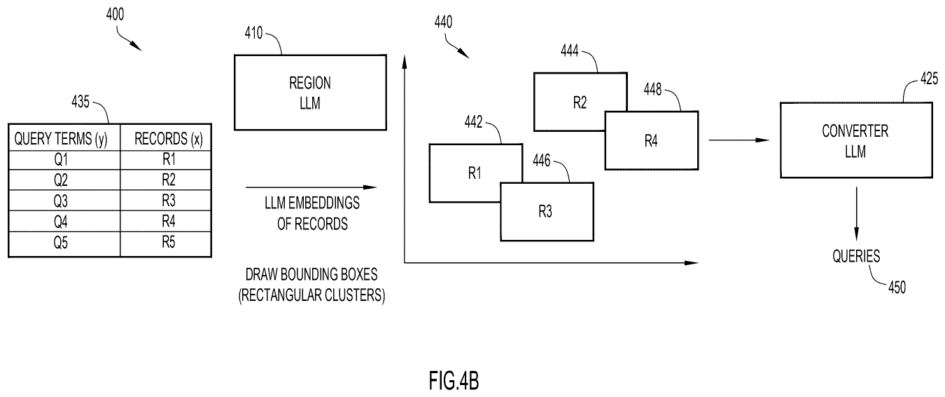

The latent or embedding space of a large language model (LLM) (e.g., LLM 300 etc.) may be leveraged to produce obfuscated queries. Referring to FIG. 4A, a first machine learning model (e.g., region LLM 410) may be trained and used to map input text or a query 405 to a region or area 415 of the latent or embedding space based on the embedding for the query. A region of the query may be expanded or distorted along selected dimensions to produce a modified region as described below. Region LLM 410 may be implemented by, or include, any quantity of any conventional or other machine learning and/or natural language processing (NLP) models (e.g., mathematical/statistical models, classifiers, feed-forward (fully or partially connected), recurrent (RNN), convolutional (CNN), or other neural networks, deep learning models, long short-term memory (LSTM), attention-based methods/transformers, Large Language Model (LLM), entity extraction, relationship extraction, part-of-speech (POS) taggers, semantic analysis, etc.), and may be similar to or leverage LLM 300 described above (e.g., include input tokenizer 305, encoder 315, etc.).

A second machine learning model (e.g., converter LLM 425) may be trained and used to map a region or area 420 of the latent or embedding space to output text or a modified query 430 based on the embeddings (or dimensions) for the region. The converter LLM receives the expanded region (or embeddings) and produces a modified query corresponding to the expanded region which is used to produce results for a search query. Converter LLM 425 may be implemented by, or include, any quantity of any conventional or other machine learning and/or natural language processing (NLP) models (e.g., mathematical/statistical models, classifiers, feed-forward (fully or partially connected), recurrent (RNN), convolutional (CNN), or other neural networks, deep learning models, long short-term memory (LSTM), attention-based methods/transformers, Large Language Model (LLM), entity extraction, relationship extraction, part-of-speech (POS) taggers, semantic analysis, etc.), and may be similar to or leverage LLM 300 described above (e.g., include decoder 325, output tokenizer 335, etc.).

A method 400 of training large language models (LLMs) 410, 425 (e.g., via query obfuscation code 200, computer 101, etc.) according to an embodiment of the present invention is illustrated in FIG. 4B. Initially, region LLM 410 is trained by query module 220 to map queries to regions of records in the embedding space. The region LLM is trained on a training set 435 including queries of one or more terms (e.g., Q1 to Q5 as shown in FIG. 4B) and corresponding results or records (e.g., sets of records R1 to R5 for the results as shown in FIG. 4B) from a synthetic data set (e.g., National Institute of Standards and Technology (NIST) Text Retrieval Conference (TREC) Query Data Set, etc.). For example, queries (e.g., Q1 to Q5 as shown in FIG. 4B) of training set 435 are performed on the synthetic data set that result in a corresponding set of URIs (or records) (e.g., R1 to R5 as shown in FIG. 4B) for the training set. Embeddings are determined for records of each set of records (or URIs), where the embeddings of the records may be bounded by dimensions to form a region or area in a latent or embedding space 440 containing that set of records (e.g., region 442 containing embeddings for records of R1, region 444 containing embeddings for records of R2, region 446 containing embeddings for records of R3, and region 448 containing embeddings for records of R4 as shown in FIG. 4B). The dimensions of the regions are indicated by coordinates in the embedding space encompassing the embeddings of the records within that region, and depend on the shape of the region.

The dimensions of a region or area may be bound in various manners for a set of records returned from a query. For example, rectangular shaped regions may be used to bound the set of records. By way of example, the lowest and upper-most dimensions of the latent representation (or embeddings) of the records may be bounded to form the rectangular shaped region (e.g., the lowest and upper-most values of embeddings of the records (representing corners) may be used to indicate length and width of the region). Further, the records may be bounded based on a percentile (e.g., embedding at or near a certain percentile (e.g., at least the 90th percentile, etc.) of the embeddings of records, etc.) or other statistical measure of each dimension (e.g., length and width) in the latent representation to form the rectangular shaped region.

By way of further example, circular shaped regions may be used to bound the set of records. For example, the records may be clustered, via any conventional or other clustering technique, and a centroid and radius (from the cluster) may be used to bound the records in a circular shaped region.

Region LLM 410 is trained on training set 435 to map an input query to a region (based on mapping embeddings for the query to embeddings of the region). The queries of training set 435 are processed by region LLM 410 to produce embeddings for the query and map the query (or embeddings) to a region. The region LLM may produce embeddings of the query in substantially the same manner described above (FIG. 3). The result (or region) produced by the region LLM is compared to the known region from the training set. The region LLM is adjusted based on the difference between the result from region LLM 410 and the known region (e.g., difference between (e.g., embeddings or dimensions of) the produced and known regions, etc.) in substantially the same manner described above (e.g., until the difference satisfies a threshold, etc.).

The trained region LLM may receive a query and produce a region corresponding to the query (based on mapping embeddings for the query to embeddings of the region). This region or area may be distorted (expanded or shifted) along various dimensions to produce distorted regions corresponding to modified queries as discussed below. For example, with respect to rectangular shaped regions, a dimension in each of the two dimensions (e.g., length and width) of the rectangular shaped region in a multi-dimensional embedding space may be extended or shifted by an amount (δ). With respect to circular shaped regions, a centroid may be shifted along a randomly selected vector in the embedding space.

Converter LLM 425 is trained to translate or map a region (of records) in an embedding space to a query. The converter LLM is trained on training set 435 including queries (e.g., Q1 to Q5 as shown in FIG. 4B) and corresponding results or records (e.g., sets of records R1 to R5 for the results as shown in FIG. 4B) from the synthetic data set (e.g., National Institute of Standards and Technology (NIST) Text Retrieval Conference (TREC) Query Data Set, etc.). For example, queries (e.g., Q1 to Q5 as shown in FIG. 4B) of training set 435 are performed on the synthetic data set that result in a corresponding set of URIs (or records) (e.g., R1 to R5 as shown in FIG. 4B) for the training set. Embeddings are determined for records of each set of records (or URIs), where the embeddings of the records may be bounded by dimensions to form a region or area in latent or embedding space 440 containing that set of records (e.g., region 442 containing embeddings for records of R1, region 444 containing embeddings for records of R2, region 446 containing embeddings for records of R3, and region 448 containing embeddings for records of R4 as shown in FIG. 4B) in substantially the same manner described above. The dimensions of the regions are indicated by coordinates in the embedding space encompassing the embeddings of the records within that region, and depend on the shape of the region.

The converter LLM is trained on training set 435 to map a region of records to a query (based on mapping embeddings of the region to embeddings of a query). The regions of records from training set 435 are processed by converter LLM 425 to map a region to a query. The converter LLM maps embeddings of the region to an embedding of a query, and produces a text query from the embedding in substantially the same manner described above (FIG. 3). The result (or query) produced by the converter LLM is compared to the known query from the training set. The converter LLM is adjusted based on the difference between the result from converter LLM 425 and the known query (e.g., difference between embeddings of the produced and known queries, etc.) in substantially the same manner described above (e.g., until the difference satisfies a threshold, etc.). The trained converter LLM may receive a region (or corresponding dimensions or embeddings) and produce a query 450 corresponding to the region (based on mapping embeddings for the region to embeddings of the query).

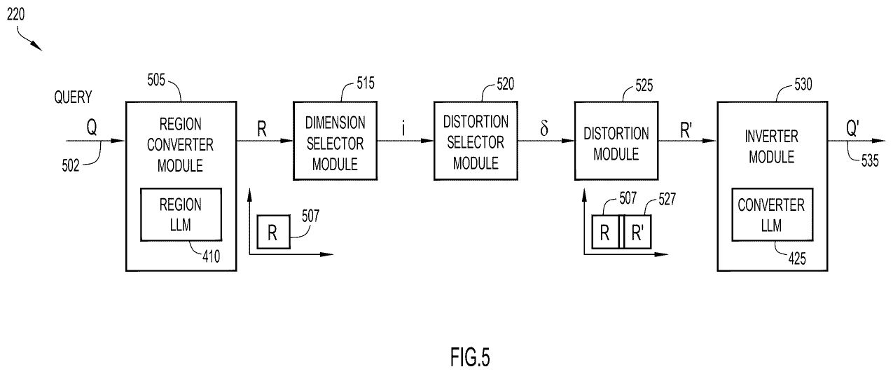

A manner of generating modified queries (e.g., via query module 220, computer 101, etc.) according to an embodiment of the present invention is illustrated in FIG. 5. Initially, query module 220 includes a region converter module 505, a dimension selector module 515, a distortion selector module 520, a distortion module 525, and an inverter module 530. Query module 220 receives a search query 502 (e.g., Q as viewed in FIG. 5) from a user (e.g., via a user device 103, etc.) or other entity (e.g., application, device, etc.). Region converter module 505 includes region LLM 410 that processes search query 502 to produce a region (of records) 507 in an embedding space for the search query (e.g., R as viewed in FIG. 5) in substantially the same manner described above. Various shaped regions may be used to bound a set of records returned from a query as discussed above. The region LLM may produce any information or attributes indicating or describing the region (e.g., the lowest and upper-most dimensions of the latent representation (or embeddings) of the records, a percentile or other statistical measure of each dimension in the latent representation, a centroid and radius, etc.).

Dimension selector module 515 randomly selects a dimension of region 507 (e.g., a dimension i from among the dimensions of the embedding space of region LLM 410). The selection may be based on any conventional or other random number generator or randomization technique. For example, a random number may be generated that corresponds to a dimension.

Distortion selector module 520 randomly selects an amount of distortion, δ, to apply to the selected dimension of region 507. The selection may be based on any conventional or other random number generator or randomization technique. For example, a random number may be generated in a distortion range that corresponds to the amount of distortion (e.g., expansion or shift along the selected dimension).

Distortion module 525 distorts region 507 along the selected dimension, i, for the selected amount of distortion, δ, to from distorted region 527 (e.g., R′ as viewed in FIG. 5). This adjusts a result set that corresponds to a modified query different than search query 502 producing results in region 507. For example, with respect to rectangular shaped regions, the selected dimension, i (e.g., length or width), may be extended or shifted by the selected distortion amount, δ, in the embedding space. With respect to circular shaped regions, a centroid may be shifted by the selected distortion amount, δ, along a randomly selected vector (e.g., corresponding to the randomly selected dimension, i) in the embedding space.

Inverter module 530 includes converter LLM 425 that maps distorted region 527 to a modified text query 535 (e.g., Q′ as viewed in FIG. 5) in substantially the same manner described above. The modified query corresponds to (or produces) results in the distorted region. This process may be repeated to distort (e.g., expand or shift) the region along various dimensions and produce any quantity of modified queries.

Query module 220 further produces decoy queries for search query 502 that generally produce results unrelated to search query 502. The decoy queries may be produced via any conventional or other techniques (e.g., selecting decoy queries from a static set, using a large language model (LLM) to generate the decoy queries, etc.). For example, one or more regions of the embedding space are randomly selected and converted to decoy queries (e.g., via converter LLM 425). The selection may be based on any conventional or other random number generator or randomization technique. For example, a random number may be generated that corresponds to a region in the embedding space for conversion to a modified query.

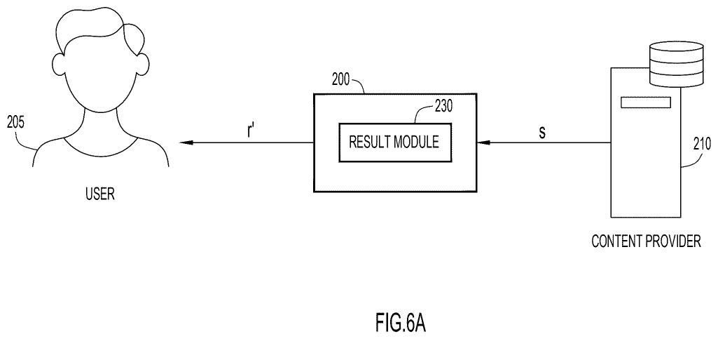

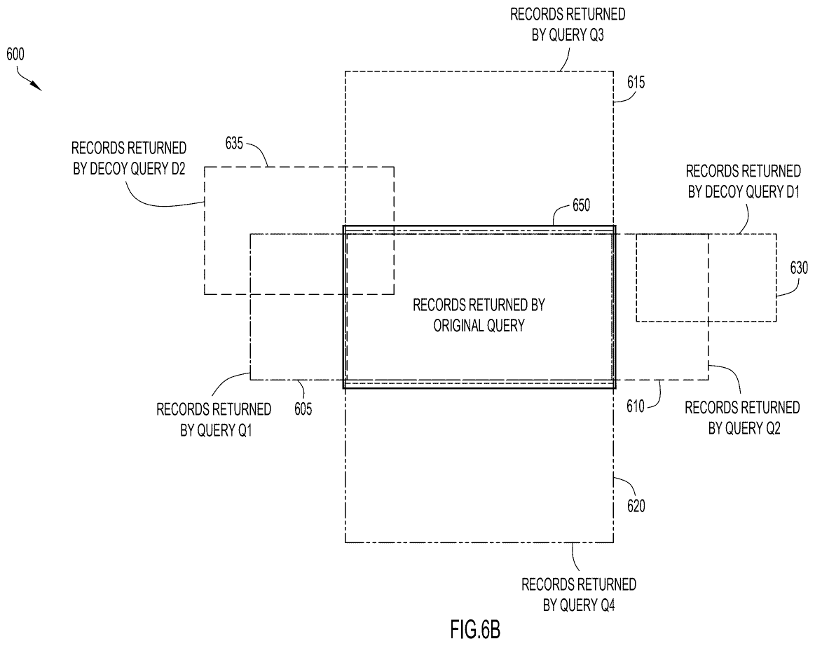

A manner of combining results from the obfuscated queries (e.g., via result module 230, computer 101, etc.) according to an embodiment of the present invention is illustrated in FIG. 6A. Initially, a user 205 (e.g., via an end user device 103, etc.) or other entity (e.g., application, device, etc.) provides a query to computer 101 including query obfuscation code 200. The query obfuscation code includes query module 220 for producing obfuscated queries for the query in substantially the same manner described above, and result module 230 to combine results of the obfuscated queries (e.g., s as viewed in FIG. 6A) to produce a result for the query (e.g., r′ as viewed in FIG. 6A). The obfuscated queries include modified queries produced from the query (based on distorted regions as described above), and may further include decoy or dummy queries.

The obfuscated queries from query module 220 are provided to a content provider 210 (e.g., search engine, database, data source, etc.) that retrieves information satisfying the obfuscated queries and produces results for the obfuscated queries. In other words, each obfuscated query returns a set of one or more records from content provider 210 (e.g., links from a search engine, database records, etc.). Result module 230 produces embeddings for the sets of records, and determines bounds of regions for the records for each obfuscated query in an embedding space in substantially the same manner described above. The results associated with the modified queries are processed by result module 230 to produce a result for the query. Thus, a response from directly processing the query may be reconstructed from results of the modified queries (e.g., while ignoring or discarding results of the decoy queries).

A manner of producing a response to a query based on results from obfuscated queries is illustrated in FIG. 6B. The response is basically a reconstruction of the results of directly applying the original query to a content provider. The determination of the response is described with respect to rectangular shaped regions. However, the response may be determined for any shaped regions of spaces of any quantity of dimensions in substantially the same manner described below.

By way of example, a query is processed to produce obfuscated queries including modified queries Q1, Q2, Q3, Q4 (based on distorted regions) and decoy or dummy queries D1 and D2 in substantially the same manner described above. Each modified and decoy query (instead of the original query) is provided to a content provider that returns a set of one or more records (e.g., links from a search engine, records from a database, etc.).

Each record may be represented as a point in an abstract multi-dimensional vector space (e.g., embedding space 600, etc.). Result module 230 produces embeddings for the sets of records, and determines bounds of regions for the records for each obfuscated query in embedding space 600 in substantially the same manner described above. For example, query Q1 returns a set of records with embeddings in a region 605 of embedding space 600, query Q2 returns a set of records with embeddings in a region 610 of the embedding space, query Q3 returns a set of records with embeddings in a region 615 of the embedding space, and query Q4 returns a set of records with embeddings in a region 620 in the embedding space. Similarly, decoy query D1 returns a set of records with embeddings in a region 630 of the embedding space, while decoy query D2 returns a set of records with embeddings in a region 635 of the embedding space.

The response to the original query may be produced by result module 230 by determining the records within an intersection of the regions of the modified queries (e.g., region 605 for modified query Q1, region 610 for modified query Q2, region 615 for modified query Q3, and region 620 for modified query Q4), while ignoring the regions for the decoy queries (e.g., region 630 for decoy query D1 and region 635 for decoy query D2). The intersection may be determined based on the dimensions of the regions for the modified queries (e.g., embeddings for a record reside within the dimensions of each of the regions for the modified queries, etc.).

Further, the response may be determined by applying the original query to the records of the modified queries (e.g., records in regions 605, 610, 615, and 620 of the modified queries Q1, Q2, Q3, and Q4).

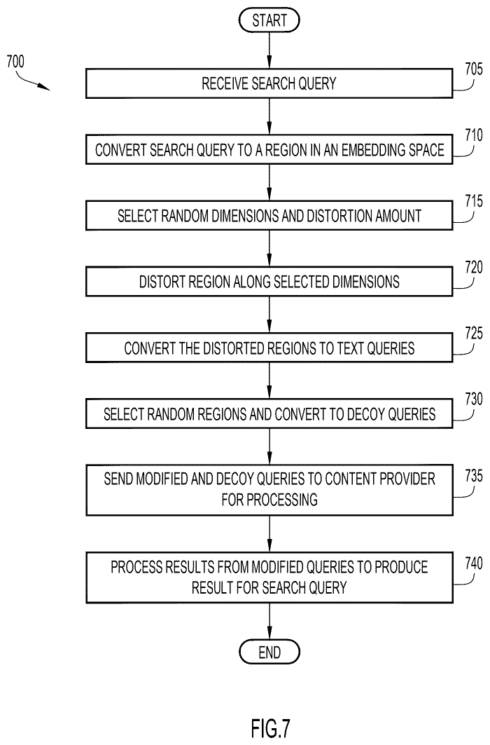

A method 700 of obfuscating a query (e.g., via query obfuscation code 200, computer 101, etc.) according to an embodiment of the present invention is illustrated in FIG. 7. Initially, a search query is received from a user (e.g., via a user device 103, etc.) or other entity (e.g., application, device, etc.) at operation 705. The search query is processed (e.g., via region LLM 410 of query module 220) to determine a corresponding region (of records) in an embedding space for the search query at operation 710 in substantially the same manner described above. Various shaped regions may be used to bound a set of records returned from a query as described above.

One or more dimensions of the region (e.g., from among the dimensions of an embedding space of region LLM 410) and an amount of distortion are selected at operation 715. The dimensions and amount of distortion may be randomly selected based on any conventional or other random number generator or randomization technique in substantially the same manner described above.

The region for the search query is distorted (e.g., expanded or shifted) along the selected dimensions for the selected distortion amount at operation 720 to produce distorted regions (e.g., with records corresponding to modified queries different than the search query). The distorted regions are converted to modified (text) queries (e.g., via converter LLM 425) at operation 725 in substantially the same manner described above. One or more regions of the embedding space are randomly selected and converted to decoy queries (e.g., via converter LLM 425) at operation 730 in substantially the same manner described above.

The modified and decoy queries are sent to the content provider at operation 735 to obtain results for the obfuscated queries, and the content provider returns a set of records for each query. The records for the modified queries are processed to produce a response to the original query at operation 740 in substantially the same manner described above. For example, the records within an intersection of the regions of the modified queries may be determined and used as the result, while ignoring the regions for the decoy queries. The intersection may be determined based on embeddings for a record residing within the dimensions of each of the regions for the modified queries as described above. Further, the response may be produced by applying the original query to the records of the modified queries (e.g., with or without the records of the decoy queries) in substantially the same manner described above.

Present invention embodiments provide various technical and other advantages. For example, present invention embodiments provide enhanced security for searches by obfuscating queries to conceal the intent or target of a search. The large language models (LLMs) may be configured to control the level of security or obfuscation (e.g., quantity of regions, amount of distortion or dimensions, quantity of decoy queries, etc.), thereby controlling computer performance and conserving computing resources. Further, present invention embodiments produce results for a query without sending the query to a content provider. This provides enhanced security by enabling performance of the query without exposing the intent or target of the search. Moreover, the security is provided without use of ontologies or knowledge graphs which require resources for updating and maintenance.

It will be appreciated that the embodiments described above and illustrated in the drawings represent only a few of the many ways of implementing embodiments for query obfuscation for secure searches.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., query obfuscation code 200, query module 220, result module 230, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., queries, results, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

A report may include any information arranged in any fashion, and may be configurable based on rules or other criteria to provide desired information to a user (e.g., queries, results, etc.).

The present invention embodiments are not limited to the specific tasks or algorithms described above, but may be utilized for obfuscating any types of queries for any data sources.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of processing queries for secure searches comprising:
determining for a query, via a first machine learning model of at least one processor, a region of an embedding space corresponding to search results;
distorting, via the at least processor, the region of the embedding space along one or more dimensions to produce distorted regions in the embedding space corresponding to different search results;
determining, via a second machine learning model of the at least one processor, modified queries corresponding to the different search results of the distorted regions to produce obfuscated queries;
obtaining, via the at least processor, results from processing the obfuscated queries; and
producing, via the at least one processor, a response to the query based on the results for the obfuscated queries.

2. The method of claim 1, wherein the first machine learning model and the second machine learning model each include a large language model.

3. The method of claim 1, wherein the obfuscated queries include one or more decoy queries.

4. The method of claim 3, further comprising:
generating, via the at least one processor, the one or more decoy queries based on randomly selected regions in the embedding space.

5. The method of claim 1, wherein producing the response to the query comprises:
determining regions of the embedding space corresponding to the results for the obfuscated queries; and
producing the response to the query based on an intersection of the regions corresponding to the results for the modified queries.

6. The method of claim 1, wherein producing the response to the query comprises:
processing the query against the results for the obfuscated queries to produce the response.

7. The method of claim 1, wherein the region includes one of a rectangular shaped region and a circular shaped region.

8. The method of claim 1, wherein the one or more dimensions and an amount of distortion are randomly selected.

9. A system for processing queries for secure searches comprising:
one or more memories; and
at least one processor coupled to the one or more memories, and configured to:
determine for a query, via a first machine learning model, a region of an embedding space corresponding to search results;
distort the region of the embedding space along one or more dimensions to produce distorted regions in the embedding space corresponding to different search results;
determine, via a second machine learning model, modified queries corresponding to the different search results of the distorted regions to produce obfuscated queries;
obtain results from processing the obfuscated queries; and
produce a response to the query based on the results for the obfuscated queries.

10. The system of claim 9, wherein the first machine learning model and the second machine learning model each include a large language model.

11. The system of claim 9, wherein the obfuscated queries include one or more decoy queries.

12. The system of claim 11, wherein the at least one processor is further configured to:
generate the one or more decoy queries based on randomly selected regions in the embedding space.

13. The system of claim 9, wherein producing the response to the query comprises:
determining regions of the embedding space corresponding to the results for the obfuscated queries; and
producing the response to the query based on an intersection of the regions corresponding to the results for the modified queries.

14. The system of claim 9, wherein producing the response to the query comprises:
processing the query against the results for the obfuscated queries to produce the response.

15. The system of claim 9, wherein the region includes one of a rectangular shaped region and a circular shaped region.

16. The system of claim 9, wherein the one or more dimensions and an amount of distortion are randomly selected.

17. A computer program product for processing queries for secure searches, the computer program product comprising one or more computer readable storage media having program instructions collectively stored on the one or more computer readable storage media, the program instructions executable by at least one processor to cause the at least one processor to:
determine, via a first machine learning model, a region of an embedding space corresponding to search results;
distort the region of the embedding space along one or more dimensions to produce distorted regions in the embedding space corresponding to different search results;
determine, via a second machine learning model, modified queries corresponding to the different search results of the distorted regions to produce obfuscated queries;
obtain results from processing the obfuscated queries; and
produce a response to the query based on the results for the obfuscated queries.

18. The computer program product of claim 17, wherein the first machine learning model and the second machine learning model each include a large language model.

19. The computer program product of claim 17, wherein the obfuscated queries include one or more decoy queries.

20. The computer program product of claim 19, wherein the program instructions further cause the at least one processor to:
generate the one or more decoy queries based on randomly selected regions in the embedding space.

21. The computer program product of claim 17, wherein producing the response to the query comprises:
determining regions of the embedding space corresponding to the results for the obfuscated queries; and
producing the response to the query based on an intersection of the regions corresponding to the results for the modified queries.

22. The computer program product of claim 17, wherein producing the response to the query comprises:
processing the query against the results for the obfuscated queries to produce the response.

23. The computer program product of claim 17, wherein the region includes one of a rectangular shaped region and a circular shaped region, and the one or more dimensions and an amount of distortion are randomly selected.

24. A method of processing queries for secure searches comprising:
distorting, via at least processor, a region of an embedding space corresponding to search results for a query along one or more dimensions to produce distorted regions in the embedding space corresponding to different search results;
determining, via the at least one processor, modified queries corresponding to the different search results of the distorted regions to produce obfuscated queries; and
producing, via the at least one processor, a response to the query based on results for the obfuscated queries.

25. A computer program product for processing queries for secure searches, the computer program product comprising one or more computer readable storage media having program instructions collectively stored on the one or more computer readable storage media, the program instructions executable by at least one processor to cause the at least one processor to:
distort a region of an embedding space corresponding to search results for a query along one or more dimensions to produce distorted regions in the embedding space corresponding to different search results;
determine modified queries corresponding to the different search results of the distorted regions to produce obfuscated queries; and
produce a response to the query based on results for the obfuscated queries.
